(19) United States
(12) Patent Application Publication
(10) Pub. No.: US 2010/0175498 A1
(43) Pub. Date: Jul. 15, 2010

(54) ADJUSTMENT MECHANISM

(75) Inventors: Jung-Wen Chang, Tao Yuan Shien (TW); Wen-Ji Tsai, Taipei County (TW); Wan-Chi Lin, Taichung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: QUANTA COMPUTER INC., Tao Yuan Shien (TW)

(21) Appl. No.: 12/410,522

(22) Filed: Mar. 25, 2009

(30) Foreign Application Priority Data
Jan. 9, 2009 (TW) 98200299

(51) Int. Cl. G05G 5/06

(52) U.S. Cl. 74/530

(57) ABSTRACT

An adjustment mechanism is provided and includes a main body having a first ratchet portion, a slider movably connected to the main body, a button having a second ratchet portion, and an elastic member connecting the slider and the button. When the elastic member exerts a spring force on the button with the first and second ratchet portions engaged with each other, the slider is movable relative to the main body only in a first direction. When the button is pressed along a second direction, the second ratchet portion disengages from the first ratchet portion, so that the slider is movable relative to the main body in the first direction or in the other direction opposite to the first direction.

### CROSS REFERENCE TO RELATED APPLICATIONS

This application claims priority of Taiwan Patent Application No. 098200299 filed on Jan. 9, 2009, the entirety of which is incorporated by reference herein.

### TECHNICAL FIELD

The invention relates in general to an adjustment mechanism and in particular to an adjustment mechanism having ratcheted structures.

### DESCRIPTION OF THE RELATED ART

Conventional adjustable holders usually comprise retractable positioning mechanisms suitable for objects with different dimensions. The adjustable holder usually comprises a continuous or stepped adjustment mechanism which has lots of components and requires complex assembling processes. Thus, improving convenience and simplicity of the adjustment mechanisms, have been critical issues for those in the adjustment mechanism field.

### BRIEF SUMMARY

The present application provides an adjustment mechanism including a main body having a first ratchet portion, a slider movably connected to the main body, a button having a second ratchet portion, and an elastic member connecting the slider and the button. When the elastic member exerts a spring force on the button with the first and second ratchet portions engaged with each other, the slider is movable relative to the main body only in a first direction. When the button is pressed along a second direction, the second ratchet portion disengages from the first ratchet portion, so that the slider is movable relative to the main body in the first direction or in the other direction opposite to the first direction.

### BRIEF DESCRIPTION OF DRAWINGS

The application can be more fully understood by reading the subsequent detailed description and examples with references made to the accompanying drawings, wherein:

FIG. 1A is an exploded diagram of an adjustment mechanism according to an embodiment of the invention;

FIG. 1B is a perspective diagram of the adjustment mechanism of FIG. 1 after assembly;

FIG. 2 is a perspective diagram of an adjustment mechanism when a first ratchet portion engages with a second ratchet portion; and

FIG. 3 is a perspective diagram of an adjustment mechanism when second ratchet portion disengages from the first ratchet portion.

### DETAILED DESCRIPTION

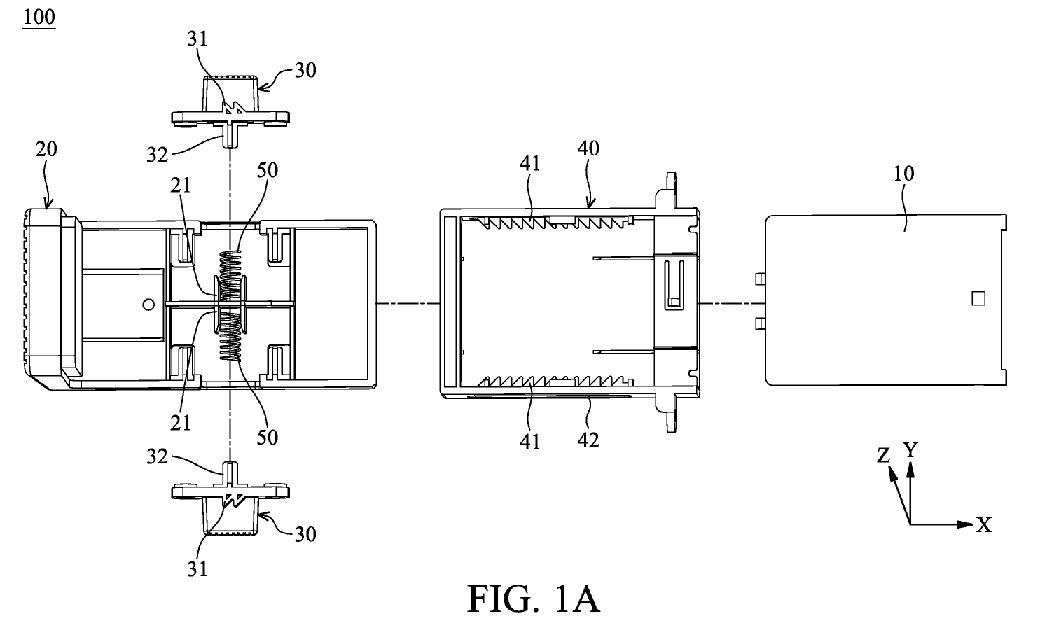

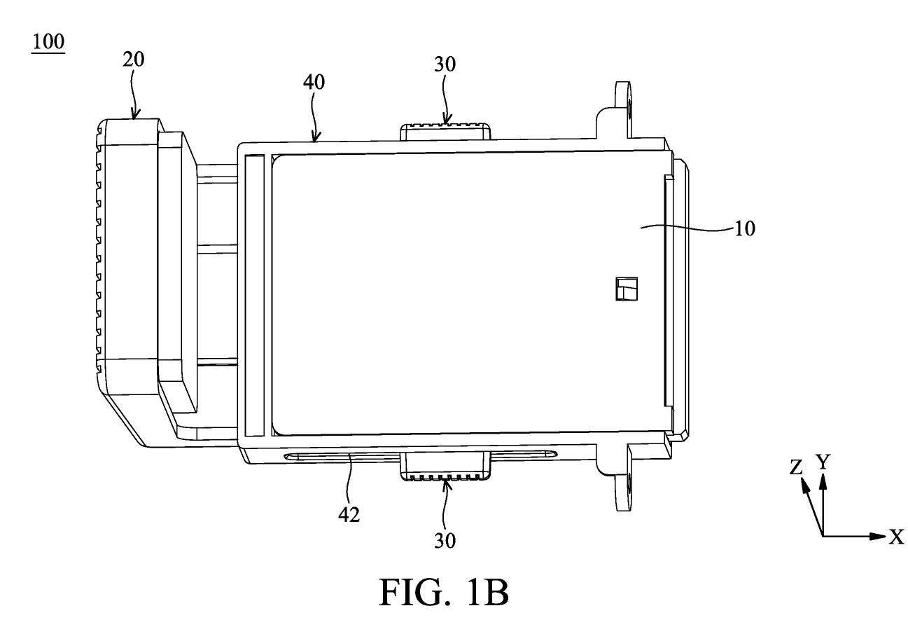

Referring to FIGS. 1A and 1B, an embodiment of an adjustment mechanism 100 comprises a cover 10, a slider 20, two buttons 30, a main body 40, and two elastic members 50 (such as springs). In FIG. 1A, the main body 40 has two first ratchet portions 41, and each of the buttons 30 has a second ratchet portion 31 respectively corresponding to the two first ratchet portions 41. During assembly, the slider 20 is slid into the main body 40, and the two buttons 30 are respectively inserted though the longitudinal openings 42 from opposite sides of the main body 40. Subsequently, the elastic members 50 are respectively disposed in the slots 21 of the slider 20, wherein two protrusions 32 of the buttons 30 are joined with the elastic members 50. Finally, as shown in FIG. 1B, the cover 10 is mounted on the main body 10.

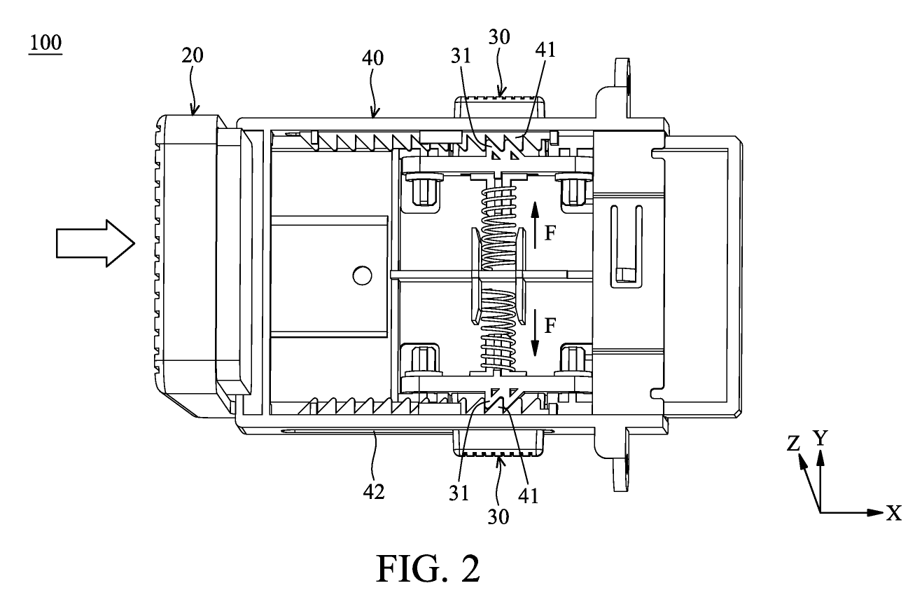

After assembly of the adjustment mechanism 100, each of the elastic members 50 is compressed and exerts a preload spring force F outwardly on the button 30, as shown in FIG. 2, so that the first and second ratchet portions 41 and 31 engage with each other. When the slider 20 slides relative to the main body 40, the buttons 30 respectively move along the longitudinal openings 42.

Referring to FIG. 2, when the adjustment mechanism 100 switches to a retracted state, the slider 20 is inserted or pushed into the main body 40 along the X direction (first direction). In this embodiment, the first ratchet portion 41 and the second ratchet portion 31 are ratchet racks which extend along an X axis and have a plurality of unidirectional ratchet teeth. Hence, when the slider 20 moves relative to the main body 40 along the X direction, the second ratchet portion 31 is pressed by the first ratchet portion 41 and temporarily released therefrom. Subsequently, the second ratchet portion 31 engages with the first ratchet portion 41 again by the spring force F of the elastic member 50. The two repeated motions facilitate stepped movement and unidirectional adjustment between the first and second ratchet portions 41 and 31.

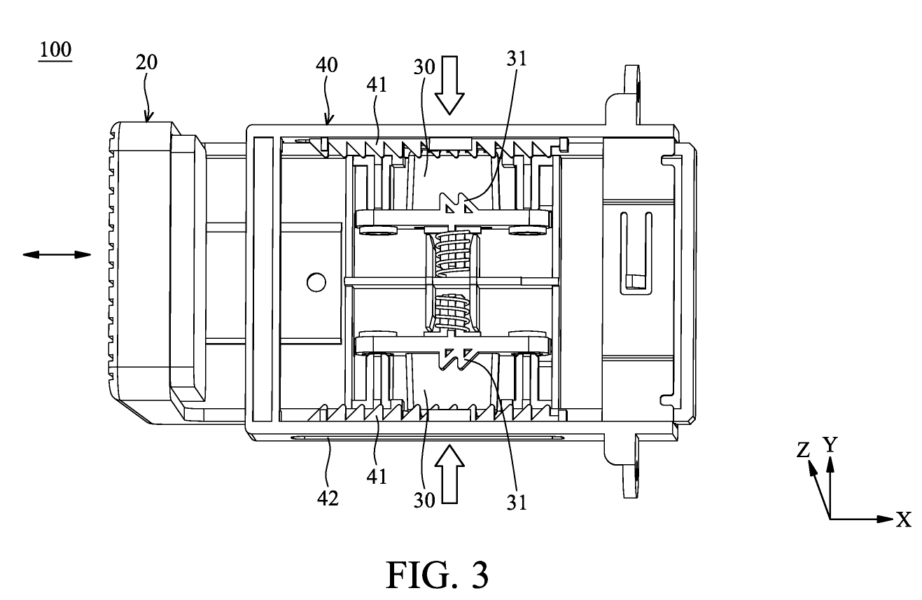

The adjustment mechanism 100 also allows bidirectional continuous movement between the slider 20 and the main body 40. As shown in FIG. 3, when the buttons 30 are pressed toward the center of the main body 40 along a second direction, substantially perpendicular to the X axis, the second ratchet portions 31 disengage from the first ratchet portions 41. Hence, the slider 20 can rapidly slide relative to the main body 40 along the X or −X direction without interference between the first and second ratchet portions 41 and 31.

The invention provides an adjustment mechanism capable of continuous or stepped adjustment. In an exemplary embodiment, the adjustment mechanism comprises a main body and a slider which is retractable with respect to the main body in a stepped manner. Additionally, when the buttons are pressed toward the center of the main body, the slider is released and capable of continuous and bidirectional sliding with respect to the main body. The adjustment mechanism is easy to assemble and facilitates either continuous or stepped adjustment with reduced production cost while improving convenience of usage.

While the invention has been described by way of example and in terms of embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An adjustment mechanism, comprising:
a main body, comprising a first ratchet portion;
a slider, movably connected to the main body;
a button, comprising a second ratchet portion; and
an elastic member connecting the slider and the button, wherein when the elastic member exerts a spring force on the button to engage the second ratchet portion with the first ratchet portion, the slider is movable relative to the main body only in a first direction, and when the button is pressed along a second direction, the second ratchet portion disengages from the first ratchet portion, and the slider is movable relative to the main body in the first direction or in the other direction opposite thereto.

2. The adjustment mechanism as claimed in claim 1, wherein the elastic member is a spring.

3. The adjustment mechanism as claimed in claim 1, wherein the slider comprises a slot receiving the elastic member.

4. The adjustment mechanism as claimed in claim 1, wherein the button further comprises a protrusion joined with the elastic member.

5. The adjustment mechanism as claimed in claim 1, wherein the first ratchet portion comprises a ratchet rack having a plurality of ratchet teeth.

6. The adjustment mechanism as claimed in claim 1, wherein the first ratchet portion extends along the first direction.

7. The adjustment mechanism as claimed in claim 1, wherein the main body further comprises a longitudinal opening with the button movably disposed therethrough.

8. The adjustment mechanism as claimed in claim 1, wherein the adjustment mechanism further comprises a cover joined with the main body.

9. The adjustment mechanism as claimed in claim 1, wherein the slider is retracted into the main body when moving relative to the main body along the first direction.

10. The adjustment mechanism as claimed in claim 1, wherein the second direction is substantially perpendicular to the first direction.

11. The adjustment mechanism as claimed in claim 1, wherein the adjustment mechanism further comprises two buttons and two elastic members respectively disposed at opposite sides of the main body.

12. The adjustment mechanism as claimed in claim 3, wherein the button further comprises a protrusion joined with the elastic member.

13. The adjustment mechanism as claimed in claim 12, wherein the first ratchet portion extends along the first direction.

14. The adjustment mechanism as claimed in claim 13, wherein the main body further comprises a longitudinal opening with the button movably disposed therethrough.

15. The adjustment mechanism as claimed in claim 14, wherein the adjustment mechanism further comprises a cover joined with the main body.

16. The adjustment mechanism as claimed in claim 15, wherein the slider is retracted into the main body when moving relative to the main body along the first direction.

17. The adjustment mechanism as claimed in claim 16, wherein the second direction is substantially perpendicular to the first direction.

18. The adjustment mechanism as claimed in claim 17, wherein the adjustment mechanism further comprises two buttons and two elastic members respectively disposed at opposite sides of the main body.

19. The adjustment mechanism as claimed in claim 18, wherein the first ratchet portion comprises a ratchet rack having a plurality of ratchet teeth.
